(19) United States
(12) Patent Application Publication
(10) Pub. No.: US 2026/0010160 A1
(43) Pub. Date: Jan. 8, 2026

(54) METHOD AND SYSTEM FOR ENHANCING ROBOT CAPABILITIES

(71) Applicant: Telecom Italia S.p.A., Milano (IT)

(72) Inventors: Roberto Antonini, Torino (IT); Marco Gaspardone, Torino (IT)

(21) Appl. No.: 18/881,788

(22) PCT Filed: Jul. 6, 2023
(86) PCT No.: PCT/EP2023/068677

§ 371 Date: Jan. 7, 2025

(30) Foreign Application Priority Data
Jul. 8, 2022 (IT) 102022000014449

(51) Int. Cl. G05D 1/225; B25J 9/16; G05D 1/226; G06F 8/61

(52) U.S. Cl. CPC G05D 1/225; B25J 9/1656; G05D 1/226; G06F 8/61; G05B 2219/39001

(57) ABSTRACT

A method for controlling the operation of a robot in an environment is provided. The robot is configured to exchange data with a remote server by establishing a robot-remote server communication through a communication network. The method comprises: having the robot be required to perform a task in the environment; generating a robot procedure for executing the task, the robot procedure comprising a corresponding set of procedures each corresponding to one or more software applications comprising instructions for controlling the robot; selecting a set of at least one device, each device having a processing unit configured to execute at least one software application, each device being located in the environment; the remote server causing each device to download and install at least one software applications; having the robot perform the robot procedure at least partially under the control of commands sent by at least one device.

### CROSS-REFERENCE TO RELATED APPLICATION(S)

This Application is a U.S. national stage of PCT/EP2023/068677, filed Jul. 6, 2023, which claims priority to Italian Patent Application no, 102022000014449, filed Jul. 8, 2022, the entire contents of which are incorporated herein by reference.

### BACKGROUND OF THE PRESENT INVENTION

### Field of the Present Invention

The present invention generally relates to the fields of robots. More particularly, the present invention relates to a method and a system for enhancing processing capabilities of a robot.

### Overview of the Related Art

With the term of robot it is herein intended any kind of machine capable of carrying out tasks—such as for example opening a closed door, grab an object and transport it to another location—autonomously, i.e., by autonomously taking decisions without a direct intervention of a human user.

A robot is equipped with at least one processing device (e.g., a processor unit) adapted to process data and autonomously take decisions for accordingly controlling actuator devices of the robot in order to carry out one or more tasks.

Since the tasks to be carried out by a robot are generally complex, the processing devices onboard a robot should have sufficient processing power to be capable of managing very high computational loads. However, a processing device capable of managing very high computational loads is expensive, and/or involves a high power consumption that cannot be efficiently handled by the power sources, e.g., batteries, of a robot, without compromising the correct operation of the latter. Indeed, equipping a robot with large batteries disadvantageously encumbers the robot mobility because of the excessive volume and mass of the batteries.

A known solution for this drawback is to provide the robot with processing devices that are less expensive and/or having reduced power consumptions (that can be easily managed by the batteries of the robot), and compensate for the reduced processing power of the onboard processing devices by borrowing processing power from a cloud computing system.

However, the communication (for example, based on the internet) between the robot and remote servers of the cloud computing system may be affected by latency issues, that may compromise the correct operation of the robot in case the task to be performed by the latter needs a rapid response.

US20160182639 discloses an Internet of Things network system, and more particularly, an Internet of Things network system in which the installation and version management of an application of a virtual machine for operating a detection server device is performed through a fog computing network in response to a request from a manager so that an application specialized for the detection server device can be easily installed or managed through the fog computing network.

U.S. Pat. No. 10,788,836 discloses a method including capturing, by an image sensor disposed on a robot, images of a workspace; obtaining, by a processor of the robot or via the cloud, the captured images; comparing, by the processor of the robot or via the cloud, at least one object from the captured images to objects in an object dictionary; identifying, by the processor of the robot or via the cloud, a class to which the at least one object belongs using an object classification unit; and instructing, by the processor of the robot, the robot to execute at least one action based on the object class identified.

The paper “Multi-level Resource Sharing Framework using Collaborative Fog Environment for Smart Cities” by Tariq Qayyum, Zouheir Trabelsi, Asad Waqar Malik, and Kadhim Hayawi, IEEE Access, VOLUME 4, 2016, relates to a simulation framework for fog devices that can use end devices to handle the peak computation load to provide better Quality of Services (QoS). The regional fog nodes are deployed at network edge locations which are used as an intelligent agent to handle the computation requests by either scheduling them on local servers, cloud data centers, or at the under-utilized end-user devices. The device-to-device resource sharing model relies on Ant Colony Optimization (ACO) and Earliest Deadline First (EDF) Algorithm to provide a better quality of service using device available at multi-layer design. The concept of using IoT devices as fog nodes has improved the performance of legacy fog based systems.

### SUMMARY OF THE PRESENT INVENTION

None of the solutions known in the art is capable of improving the operation of a robot equipped with onboard processing devices having a low processing power.

The solution disclosed in US20160182639 is simply directed to the update of IoT devices.

According to the solution disclosed in U.S. Pat. No. 10,788,836, the robot is still compelled to perform tasks by exploiting its processing power.

The solution disclosed in the paper “Multi-level Resource Sharing Framework using Collaborative Fog Environment for Smart Cities” only relates to the distribution of computational load between fog nodes following computational load peaks detected by intelligent nodes.

In view of the above, Applicant has devised a solution to improve the operation of a robot equipped with onboard processing devices having a low processing power.

One or more aspects of the present invention are set out in the independent claims, with advantageous features of the same invention that are indicated in the dependent claims, whose wording is enclosed herein verbatim by reference (with any advantageous feature being provided with reference to a specific aspect of the present that applies mutatis mutandis to any other aspect thereof).

An aspect of the present invention relates to a method for controlling the operation of a robot in an environment.

The robot is configured to exchange data with a remote server by establishing a robot-remote server communication through a communication network.

The method comprises having the robot be required to perform a task in the environment.

The method comprises generating a robot procedure adapted to be performed by the robot for carrying out said task.

Said robot procedure comprises a corresponding set of procedures each one corresponding to one or more corresponding software applications comprising instructions for accordingly controlling the operation of the robot for performing the corresponding procedure.

The method comprises selecting a set of at least one device.

Each device of the set has a processing unit suitable to execute at least one of said software applications.

Each device of the set is located in the environment.

The method comprises causing each device of the set of devices to download and install at least one of said software applications.

The method comprises having the robot perform the robot procedure at least partially under the control of commands sent by at least one device of the set.

Said commands are generated by the at least one device of the set by having the processing unit of the at least a device of the set executing the instructions of the installed at least one software application.

In this way, the computational load required to allow the robot to correctly perform the various procedures for carrying out the task is handled (at least in part) by the processing units of the selected device(s) instead of being entirely handled by (a processing unit of) the robot.

According to an embodiment of the present invention, each device of the set has hardware specifications suitable to allow the device to execute at least one of said software applications.

According to an embodiment of the present invention, by hardware specifications of a device it is intended at least one among the CPU, GPU, RAM, and storage unit of the device, the processing power of its CPU and GPU, and its data communication capabilities.

According to an embodiment of the present invention, the robot comprises at least one among the following robot modules:
actuator module configured to allow interaction of the robot with the environment;
locomotion module configured to allow movement of the robot in the environment;
sensor module configured to collect data from the environment.

According to an embodiment of the present invention, said commands sent by a device of the set are commands for controlling the operation of at least one of said robot modules so as to perform at least one corresponding procedure.

According to an embodiment of the present invention, each device of the set located in the environment is capable of exchanging data with the robot by establishing a corresponding local device-robot communication link without involving the communication network.

According to an embodiment of the present invention, said commands are sent to the robot by said least one device of the set through the corresponding local device-robot communication link.

According to an embodiment of the present invention, a transmission latency of each local device-robot communication link is lower than a transmission latency of the robot-remote server communication between the robot and the remote server.

In this way, the robot is advantageously allowed to borrow processing power from other entities (the devices) without occurring in latency issues that may compromise the correct operation of the robot in case the task to be performed by the latter needs a rapid response.

According to an embodiment of the present invention, the communication between the local devices and the robot is less affected by jitter issues compared to the communication between the robot and the remote server.

According to an embodiment of the present invention, the communication between the local devices and the robot is less affected by packet loss issues compared to the communication between the robot and the remote server.

According to an embodiment of the present invention, the method further comprises having the robot inspect the environment to identify devices in the environment.

According to an embodiment of the present invention, the method further comprises having the robot collect device hardware specifications of each one of said identified devices.

According to an embodiment of the present invention, said selecting a set of at least one device comprises selecting said set of at least one device among the identified devices.

In this way, while operating in the environment, the robot is advantageously provided with a potentially large number of different devices that can be exploited to support the execution of the task.

According to an embodiment of the present invention, said selecting a set of at least one device comprises having the remote server select said set of at least one device among the identified devices based on said collected device hardware specifications.

In this way, only the devices having processing capabilities suitable to support the robot are advantageously selected.

According to an embodiment of the present invention, the method further comprises having the robot send to the remote server a robot procedure request for the generation of said robot procedure.

According to an embodiment of the present invention, said robot procedure request further comprises request parameters comprising at least one among said collected device hardware specifications, a task description describing the task to be carried out by the robot in the environment, and hardware specifications of the robot.

According to an embodiment of the present invention, the method further comprises having the remote server generate said robot procedure based on said request parameters.

In this way, the remote server is advantageously allowed to create a robot procedure that fits the actual task to be performed, and/or to select the devices having specifications suitable for supporting the robot in carrying out said specific task.

According to an embodiment of the present invention, the method further comprises having the robot collect data from the environment.

According to an embodiment of the present invention, the method further comprises having the robot send said collected data to the remote server.

According to an embodiment of the present invention, the method further comprises having the remote server generate said task description based on the received collected data.

According to an embodiment of the present invention, the method further comprises having the remote server send said generated task description to the robot.

In this way, the description of the task used by the remote server for the generation of the robot procedure is generated according to the data collected by the robot in the environment.

According to an embodiment of the present invention, the method further comprises having a user of the remote server generate said task description, and having the remote server send said generated task description to the robot.

In this way, the description of the task used by the remote server for the generation of the robot procedure is generated according to data provided by an entity different from the robot.

According to an embodiment of the present invention, the method further comprises having the remote server, once said robot procedure has been performed, cause each device of the set of devices to uninstall the at least one of said software applications that was installed in the device itself.

According to an embodiment of the present invention, each local device-robot communication link is one among:
a WiFi direct link;
a WLAN link;
a communication link established across a local cell of a mobile network operating in a core-in-a-box modality.

According to an embodiment of the present invention, said communication network comprises the internet.

Another aspect of the present invention relates to a system.

The system comprises a robot located in an environment.

The system comprises a remote server.

The robot is configured to exchange data with the remote server by establishing a robot-remote server communication through a communication network.

The system is configured to generate a robot procedure adapted to be performed by the robot for carrying out a task in the environment.

Said robot procedure comprises a corresponding set of procedures each one corresponding to one or more corresponding software applications comprising instructions for accordingly controlling the operation of the robot for performing the corresponding procedure.

The system is configured to select a set of at least one device.

Each device of the set has a processing unit suitable to execute at least one of said software applications.

Each device of the set is located in the environment and is capable of exchanging data with the robot.

The system is configured to cause each device of the set of devices to download and install at least one of said software applications.

The robot is configured to perform the robot procedure at least partially under the control of commands sent by at least one device of the set.

Said commands are generated by the at least one device of the set by having the processing unit of the at least a device of the set executing the instructions of the installed at least one software application.

According to an embodiment of the present invention, the remote server is configured to generate said robot procedure adapted to be performed by the robot for carrying out a task in the environment.

According to an embodiment of the present invention, the remote server is configured to select said set of at least one device.

According to an embodiment of the present invention, the remote server is configured to cause each device of said set of devices to download and install at least one of said software applications.

### BRIEF DESCRIPTION OF THE DRAWINGS

These and other features and advantages of the present invention will appear more clearly by reading the following detailed description of exemplary and non-limitative embodiments thereof. For its better intelligibility, the following description should be read making reference to the attached drawing, wherein:

FIG. 1A illustrates a scenario of application of embodiments of the invention;

FIG. 1B illustrates some modules of a robot operating in the scenario of FIG. 1A according to an embodiment of the present invention;

FIG. 2 is a flow chart illustrating main operations of a method for operating the robot of FIG. 1B in the scenario of FIG. 1A according to an embodiment of the present invention;

FIGS. 3A and 3B are sequence diagrams showing how a task description DTSK is generated according to two different embodiments of the invention;

FIG. 4 is a sequence diagram of main operations of the flow chart of FIG. 2 according to an embodiment of the present invention;

FIG. 5 schematically illustrates a ROS environment shared by the robot and a device of the scenario of FIG. 1A according to an embodiment of the present invention.

### DETAILED DESCRIPTION OF EXEMPLARY AND NON-LIMITATIVE EMBODIMENTS OF THE PRESENT INVENTION

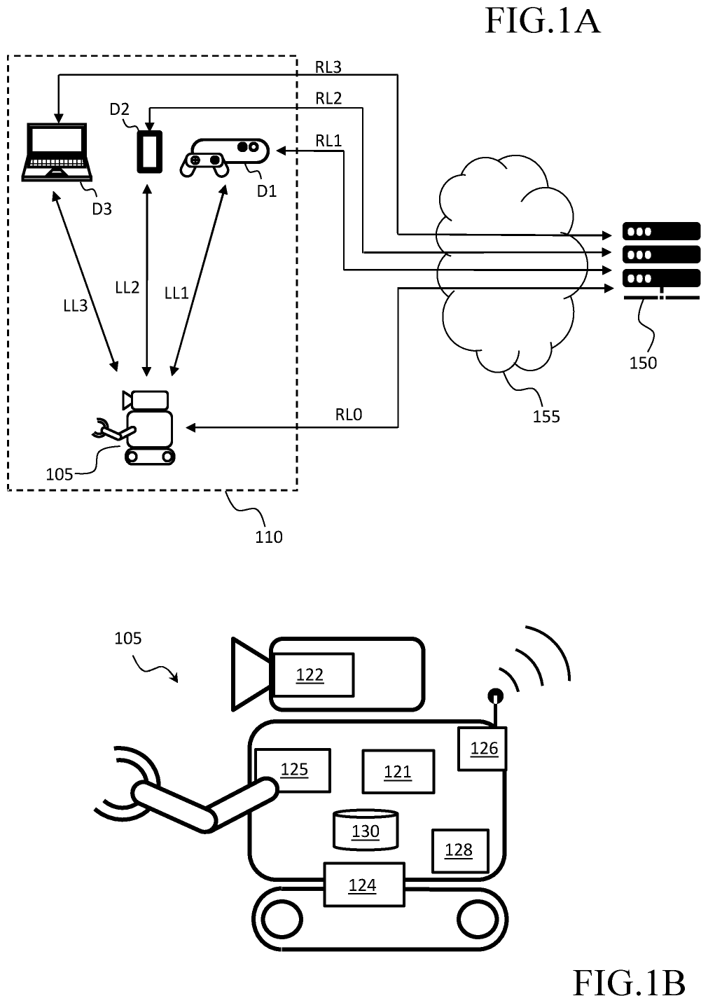

With reference to the drawings, FIG. 1A illustrates a scenario of application of embodiments of the invention in which a robot 105 located in an environment 110 (e.g., a house, a factory, a warehouse) is configured for performing tasks requiring interaction with the environment 110.

Non-limitative examples of the robot 105 may comprise an inspection robot configured to carry out patrol tasks providing for patrolling an area-such as a warehouse or an industrial plant- for assessing potential anomalous conditions, or a delivery robot configured to carry out delivery tasks providing for transporting goods from one location to another location.

As schematically illustrated in FIG. 1B, according to an embodiment of the present invention, the robot 105 may comprise several modules, whose types and functions depend on the specific application of the robot 105 itself. It should be noted that the terms ‘unit’, “system’, ‘module’ are herein intended to comprise, but not limited to, hardware, firmware, a combination of hardware and software, software. An example of possible modules included in the robot 105 is presented hereinbelow.

According to an embodiment of the present invention, the robot 105 comprises one or more processing modules 121 (e.g., one or more processor units) adapted to autonomously control the operation of one or more of the other modules of the robot 105 in order to allow the robot 105 to carry out one or more tasks.

According to an embodiment of the present invention, the robot 105 comprises one or more sensor modules 122 adapted to collect data from the environment wherein the robot 105 is operating. Examples of sensor modules 122 may comprise one or more among a camera, a proximity sensor, a temperature sensor.

According to an embodiment of the present invention, the robot 105 comprises one or more locomotion modules 124 adapted to allow movement of the robot 105 across the environment 110 wherein the robot 105 is operating. Examples of locomotion modules 124 may comprise a track or wheel system for allowing terrestrial movement of the robot 105 or a spinning rotors system for allowing aerial movement of the robot 105.

According to an embodiment of the present invention, the robot 105 comprises one or more actuator modules 125 adapted to allow interaction of the robot 105 with the environment 110 wherein the robot 105 is operating. Examples of actuator modules 125 may comprise a mechanical arm or a gripper.

According to an embodiment of the present invention, the robot 105 comprises one or more communication modules 126 (e.g., comprising a radio transceiver coupled with an antenna) adapted to wirelessly transmit and receive data to/from external devices.

According to an embodiment of the present invention, the robot 105 comprises a power supply module 128, e.g., comprising one or more batteries, for supplying electric power to the other modules of the robot 105.

According to an embodiment of the present invention, in order to describe a robot 105 from the point of view of its capability of performing tasks, the robot 105 stores, for example in a memory unit 130 coupled to the processing modules 121, a robot capability list RC listing at least one among:
the processing power of its processing modules 121;
specifications of its sensor modules 122 and a description of their interfaces;
the hardware specifications of its locomotion modules 124 and a description of their interfaces;
the hardware specification of its actuator modules 125 and a description of their interfaces.

By “processing power” of a processing module it is herein intended the capacity of a processing module of performing computer operations, for example in terms of at least one among:
time required for performing operations;
number of operations that can be managed in parallel;
complexity of the operations that can be performed.

Returning to FIG. 1A, according to an embodiment of the present invention, the robot 105 is configured to exchange data with one or more remote servers 150 (only one illustrated) of a cloud computing system. For this purpose, according to an embodiment of the present invention, the communication module 126 of the robot 105 is configured to establish a corresponding communication RL0 with the remote server 150 through a communication network 155 such as the internet. For example, the communication module 126 may interface with a router device (not illustrated in the figure) providing access to the communication network 155, or may access the communication network 155 through a mobile communication network (not illustrated in the figure) if the communication module 126 is equipped with a SIM/eSIM card/module.

According to an embodiment of the present invention, the (communication module 126 of the) robot 105 is also configured to establish local communication links LLi with electronic devices Di (i=1, 2, . . . ) located in the environment 110, and close to the actual position of the robot 105.

According to an embodiment of the present invention, the devices Di may be any kind of electronic device that is located in the proximity of the robot 105, that is capable of establishing a local communication link LLi with the (communication module 126 of the) robot 105, and that is equipped with at least a processing module (e.g., a microprocessor). Non-limitative examples of devices Di of this kind may comprise smartphones, personal computers, smart television sets, gaming consoles, router devices, other robots, workstations.

According to an embodiment of the present invention, the local communication links LLi between the robot 105 and the devices Di are configured to allow data exchange without involving the communication network 155. According to an embodiment of the present invention, the local communication links LLi may be implemented with any of the known wireless communication technologies used for local/direct/short range data communication, such as for example WiFi direct, WLAN communication technologies. Local communication links LLi can be also established across a local cell of a mobile network operating in a “core-in-a-box” modality, i.e., exploiting a mobile network based communication that is entirely managed within a local cell, without involving the core section of the mobile network.

According to an embodiment of the present invention, the devices Di are also configured to establish a communication RLi with the communication network 155 for exchanging data with the remote server 150. For example, the devices Di are configured to interface with a router device (not illustrated in the figure) providing access to the communication network 155, and/or are equipped with a SIM/eSIM card/module allowing access to the communication network 155 through a mobile communication network.

The latency affecting data exchange through a local communication link LLi between the robot 105 and a device Di is sensibly lower than the latency affecting data exchange exploiting the communication RL0 between the robot 105 and the remote server 150. Indeed, while a data packet transported by means of the communication RL0 between the robot 105 and a remote server 150 has to travel very long distances across many network nodes of the communication network 155 (e.g., physical network nodes comprising host computers), a data packet transported along a local communication link LLi between the robot 105 and a device Di has to travel along a very short distance (the device Di and the robot 105 being located in proximity to each other), and without having to involve other network nodes. Therefore, with equal bandwidths, the direct communication between the robot 105 and a device Di in the proximity of the robot 105 benefits from a higher throughput compared to the communication between the robot 105 and the remote server 150.

Moreover, data exchange through a local communication link LLi between the robot 105 and a device Di is less affected by jitter issues compared to data exchange through the communication RL0 between the robot 105 and the remote server 150.

Similarly, data exchange through a local communication link LLi between the robot 105 and a device Di is less affected by packet loss issues compared to data exchange through the communication RL0 between the robot 105 and the remote server 150.

In general terms, the solutions according to the embodiments of the present invention provide for having the robot 105 temporarily borrow processing power from one or more selected devices Di among the devices Di in the proximity of the robot 105 when the robot 105 has to carry out a task.

According to an embodiment of the present invention, the selection of a device Di for this purpose is carried out by taking into account the specific task to be carried out by the robot 105, the robot capability list RC of the robot 105, and/or the hardware specifications SDi of the device Di. By hardware specifications SDi of the device Di it is herein intended an identification of at least one among the CPU, GPU, RAM, and storage unit of the device Di, the processing power of its CPU and GPU, and the latency of the local communication link LLi between the device Di and the robot 105.

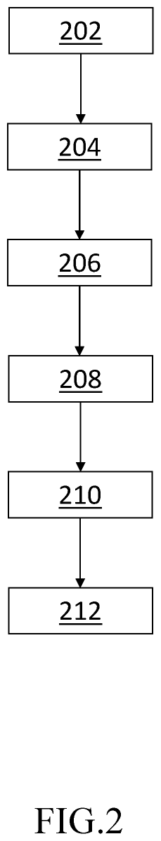

FIG. 2 is a flow chart illustrating main operations of a method for operating the robot 105 according to an embodiment of the present invention.

According to an embodiment of the present invention, the robot 105 inspects the environment 110 to identify the presence of devices Di in its proximity, and to collect the specifications SDi thereof (block 202). For this purpose, according to an embodiment of the present invention, the robot 105 scans its surrounding area with its communication module 126, for example using a long-polling transmission scan with a corresponding configurable polling time period T, and sends to each identified device Di a request message GET_SPEC( ) to get the specifications SDi of the device Di. The specifications SDi sent by the various devices Di are collected by the robot 105, for example in form of a device list DL stored at the robot 105, for example in the memory unit 130. According to an embodiment of the present invention, when a device Di is no more available, for example because the actual distance between the robot 105 and the device Di is too large for establishing a local communication link LLi or because the device Di has been turned off, its specifications SDi are removed from the device list DL.

According to an embodiment of the present invention, the robot 105 retrieves a task description DTSK describing a task TSK to be carried out by the robot 105 itself (block 204).

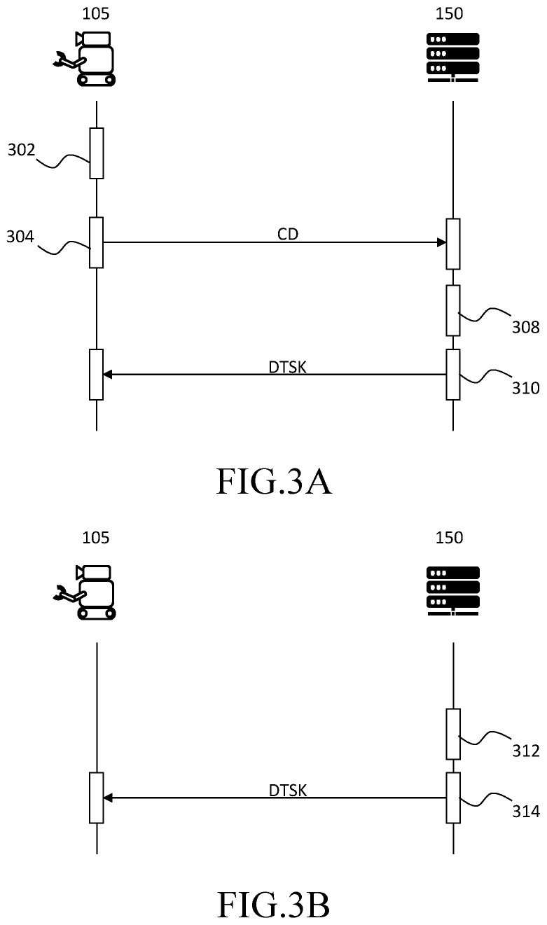

According to an embodiment of the present invention illustrated in the sequence diagram illustrated in FIG. 3A, the task description DTSK is generated in the following way.

The robot 105 collects data CD from the environment 110 using one or more of its sensor modules 122 (action 302). For example, if the robot 105 is in front of a closed door, the data CD may correspond to a picture of the closed door taken from a camera onboard the robot 105. Then, the robot 105 sends the collected data CD to the remote server 150 (action 304) exploiting the communication RL0 established between the robot 105 and the remote server 150 (see FIG. 1). Once the remote server 150 received the data CD, said data CD are processed to generate the task description DTSK (action 308). According to an embodiment of the present invention, the remote server 150 generates the task description DTSK by processing the received data CD using an Artificial Intelligence (AI) algorithm, such as for example an object recognition algorithm. By considering the example above, wherein the data CD may correspond to a picture of the closed door, the task description DTSK may thus correspond to the recognition of a ‘closed door to be opened’. Then, the task description DTSK is sent (action 310) to the robot 105 exploiting the communication RL0 established between the robot 105 and the remote server 150 (see FIG. 1).

According to another embodiment of the present invention illustrated in the sequence diagram illustrated in FIG. 3B, the task description DTSK may be directly generated by a user of the remote server 150 (action 312), and then sent (action 314) to the robot 105 exploiting the communication RL0 established between the robot 105 and the remote server 150. For example, the task description DTSK may be provided in form of natural language (for example, in the form of a string like ‘open the closed door in front of you’).

It is pointed out that the concepts of the present invention may be applied in case the task description DTSK is generated in a different way. For example, the task description DTSK may be by an object located in the environment 110 that is provided with processing and transmission capabilities. Making reference to the previous example in which the robot 105 is in front of a closed door, the door itself may be provided with hardware configured to broadcast data comprising information describing the door itself. Said data are collected by the robot 105, and sent to the remote server 150, so that the remote server 150 can use said data to generate a corresponding task description DTSK.

Returning to FIG. 2, according to an embodiment of the present invention, the remote server 150 generates a robot procedure RP adapted to be performed by the robot 105 for carrying out the task TSK described by the task description DTSK (block 206). According to an embodiment of the present invention, the robot procedure RP is generated by taking into account, in addition to the specific task TSK to be carried out (i.e., the task description DTSK), also the capabilities of the robot 105 (i.e., the robot capability list RC), and the hardware specifications SDi of the devices Di in the proximity of the robot 105 (i.e., the device list DL). According to a different embodiment of the present invention, the robot procedure RP may be generated, e.g., by the robot 105, or by one of the devices Di in the proximity of the robot 105.

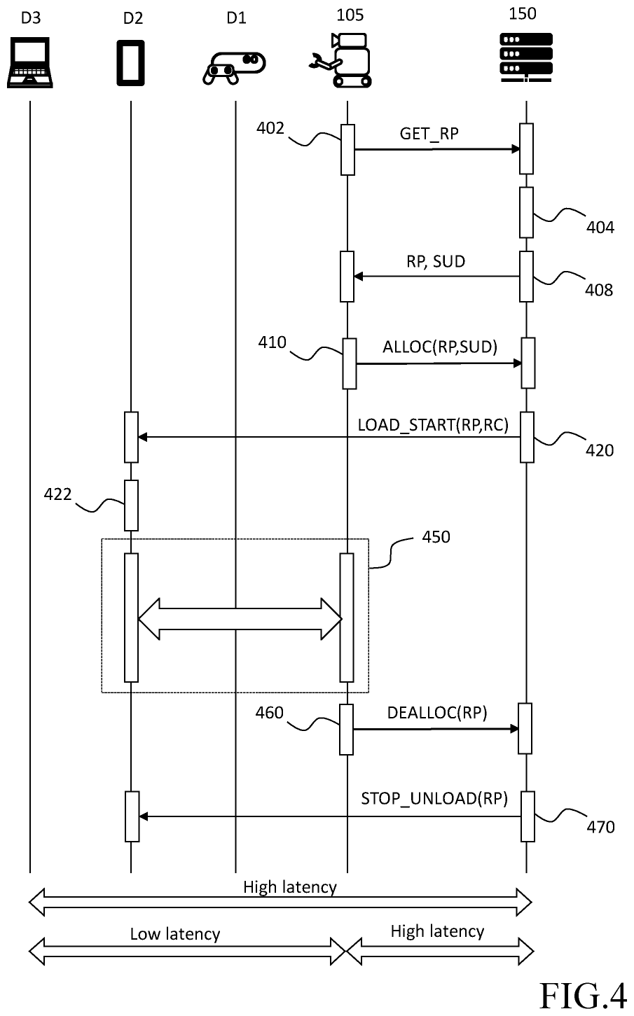

By making reference to the sequence diagram illustrated in FIG. 4, the generation of the robot procedure RP according to an embodiment of the present invention is carried out in the following way.

According to an embodiment of the present invention, the robot 105 sends (action 402) to the remote server 150 a request GET_RP to obtain a robot procedure RP exploiting the communication RL0 established between the robot 105 and the remote server 150. According to an embodiment of the present invention, the request GET_RP comprises (e.g., in the form of request parameters) the task description DTSK, the robot capability list RC, and the device list DL. In this way, the remote server 150 is provided with a description of the task TSK the robot 105 has to carry out, the capabilities of the robot 105 itself, as well as a list of the devices Di (and the specifications thereof) in proximity of the robot 105 that can be used to support the robot 105 for carrying out the task TSK.

According to an embodiment of the invention, the remote server 150 processes (action 404) the received request GET_RP to generate:
a robot procedure RP suitable to be performed by the robot 105 for carrying out the task TSK;
a supporting device list SUD specifying one or more devices Di (selected among the devices Di of the device list DL) to be used for supporting the robot 105 when performing the robot procedure RP with the processing power of their GPU and/or CPU, their RAM, their storage units and/or their connection capability.

According to an embodiment of the present invention, the robot procedure RP comprises a corresponding set of procedures Pj (j=1, 2, 3, . . . ) to be performed by the robot 105 for carrying out the task TSK. According to an embodiment of the present invention, the procedures Pj of the set are arranged in an ordered sequence that the robot 105 has to follow for correctly carrying out the corresponding task TSK. According to an embodiment of the present invention, each procedure Pj corresponds to one or more corresponding software applications SP comprising instructions executable by processing devices for accordingly controlling selected modules of the robot 105 in order to perform the procedure Pj.

According to an embodiment of the present invention, the remote server 150 generates the robot procedure RP by processing the task description DTSK using an AI algorithm capable of translating the task description DTSK into a sequence of (elementary) procedures Pj.

By making reference to the previously considered example, in which the robot 105 is in front of a closed door, and the task description DTSK may correspond to ‘closed door to be opened’ or ‘open the closed door in front of you’, the AI algorithm may generate a robot procedure RP comprising the following exemplary and non-limitative sequence of procedures Pj:
P1: identify the size and position of the door in front of you through the onboard camera;
P2: flex the onboard mechanical arm to reach the handle of the door;
P3: grab the handle with the onboard grabber connected to the mechanical arm;
P4: move the mechanical arm to open the door;
P5: identify an open condition of the door through the onboard camera;
P6: release the handle by opening the grabber once the open condition of the door is identified.

According to an embodiment of the present invention, each procedure Pj is selected by the AI algorithm running at the remote server 150 by taking into account (through the robot capability list RC) the capabilities of the robot 105. By making reference to the abovementioned example, the procedure P1 may be selected by taking into account the hardware specifications of the camera of the robot 105, the procedure P2 may be selected by taking into account the hardware specifications of the mechanical arm of the robot 105, and so on.

As will be described in greater details in the following, according to an embodiment of the present invention, the instructions of the software applications SP corresponding to a procedure Pj are advantageously executed—in addition to or in the place of the processing modules 121 of the robot 105—by the CPU/GPU of at least one of the devices Di of the supporting device list SUD. In this way, the processing power of the processing modules 121 of the robot 105 can be supported or replaced by the processing power of the CPU/GPU of at least one of the devices Di.

According to an embodiment of the present invention, the generation of the supporting device list SUD is carried out by the remote server 150 (or by another entity of the system, such as, e.g., by the robot 105, or by one of the devices Di in the proximity of the robot 105) by selecting the device(s) Di—among the devices Di in the proximity of the robot 105—whose hardware specifications SDi (particularly, the processing power of their CPU/GPU) are sufficient to allow said selected device(s) Di to execute the instructions of the software applications SP of the procedures Pj on their CPU/GPU without incurring in delays that may compromise the correct execution of the procedure Pj. According to an embodiment of the present invention, also the generation of the supporting device list SUD may be carried out by an AI algorithm running at the remote server 150.

According to a non-limitative embodiment of the present invention, a user of a device Di is able to grant/deny utilization of his/her device to support the operation of the robot 105. For example, the user may receive a remuneration if he/she allows the inclusion of his/her device Di in the supporting device list SUD.

In the example illustrated in the figures, the supporting device list SUD generated by the remote server 150 comprises a single device Di, namely the device D2.

According to an embodiment of the present invention, the generated robot procedure RP and supporting device list SUD are then sent (action 408) to the robot 105 exploiting the communication RL0 established between the robot 105 and the remote server 150.

Returning to FIG. 2, according to an embodiment of the present invention, the remote server 150 causes the installation of the software applications SP corresponding to the procedures Pj of the generated robot procedure RP into the device(s) Di listed in the supporting device list SUD (block 208). According to a different embodiment of the present invention, the installation into the device(s) Di listed in the supporting device list SUD of the software applications SP corresponding to the procedures Pj can be caused by another entity of the system, such as, e.g., by the robot 105, or by one of the devices Di in the proximity of the robot 105.

By making reference again to the sequence diagram illustrated in FIG. 4, according to an embodiment of the present invention this installation is carried out in the following way.

According to an embodiment of the present invention, the robot 105 sends (action 410) to the remote server 150 (exploiting the communication RL0 established between the robot 105 and the remote server 150) a request ALLOC_(RP, SUD) to install the software applications SP corresponding to the procedures Pj of the generated robot procedure RP into the selected device(s) Di listed in the supporting device list SUD (in the considered example, the device D2).

According to an embodiment of the present invention, the remote server 150 then sends (action 420) to the selected device(s) Di a command LOAD_START(RP, RC) for activating the selected device(s) Di, causing the selected device(s) Di to download and install the software applications SP corresponding to the procedures Pj of the generated robot procedure RP, and configuring the installed software applications SP according to the capabilities of the robot 105 (i.e., according to the capability list RC). According to an embodiment of the present invention, the command LOAD_START(RP, RC) is sent to selected device(s) Di by exploiting the communication RLi established between the remote server 150 and each one of the selected device(s) Di. In the considered example, the selected device Di is the device D2, and the command LOAD_START(RP, RC) is sent exploiting the communication RL2. According to an embodiment of the present invention, the command LOAD_START(RP, RC) comprises or is sent together with an indication of the software applications SP corresponding to the procedures Pj of the robot procedure RP and/or a way to obtain them, such as for example a list of download links DL (e.g., in the form of URLs) for downloading said software applications SP.

According to an embodiment of the present invention, the selected device Di (in the example at issue, the device D2) activates, downloads the software applications SP through the download links DL, installs them, and then configures them according to the capability list RC (action 422).

Returning to FIG. 2, according to an embodiment of the present invention, once the software applications SP corresponding to the procedures Pj of the generated robot procedure RP have been installed in the selected device(s) Di listed in the supporting device list SUD and have been configured according to the capabilities of the robot 105, the robot 105 performs the procedures Pj of the robot procedure RP with the support of the selected device(s) Di, with the CPUs/GPUs of said selected device(s) Di that execute the instructions of the software applications SP installed thereat for controlling the modules of the robot 105 (block 210).

By making reference again to the sequence diagram illustrated in FIG. 4, according to an embodiment of the present invention the robot procedure RP is performed in the following way.

The robot 105 and the selected device(s) Di establish a data connection through the corresponding local communication links LLi (in the considered example, the device D2 exchange data with the robot 105 through the local communication link LL2). Through this data connection, the robot 105 and the selected device(s) Di exchange commands and messages allowing the robot 105 to perform the procedures Pj of the robot procedure RP by having the modules thereof (e.g., the sensor modules 122 and the actuator modules 125) controlled by commands sent by the selected device(s) Di and generated by the CPUs/GPUs of the selected device(s) Di in response to the execution of instructions of the software applications SP installed thereat and to feedback generated by the sensor module(s) 122 of the robot during the execution of the procedures Pj (action 450).

In this way, according to an embodiment of the present invention, the computational load required to allow the robot 105 to correctly perform the various procedures Pj is handled (at least in part) by the CPUs/GPUs of the selected device(s) Di instead of being entirely handled by the processing module 121 of the robot 105.

In other words, according to the embodiments of the present invention, the robot 105 is allowed to temporarily borrow processing power from (the CPUs/GPUs of) devices Di in the proximity thereof for performing the robot procedure RP.

Since according to the embodiment of the present invention the robot 105 and the selected device(s) Di exchange data through local communication links LLi having a low latency, the commands sent by the selected device(s) Di to the robot 105 for controlling the operation of the modules of the robot 105, and in general the messages exchanged between the robot 105 and the selected device(s) Di are not affected by delays capable of compromising the correct execution of the robot procedure RP and therefore of the task TSK.

Conversely, if the robot 105 had to borrow processing power from the remote server 150, as in the known solutions entirely based on cloud computing systems, messages and commands exchanged between the robot 105 and the remote server 150 could have been subjected to delays because of the high latency of the communication RL0 between the robot 105 and the remote server 150, potentially compromising the correct execution of the robot procedure RP and therefore of the task TSK.

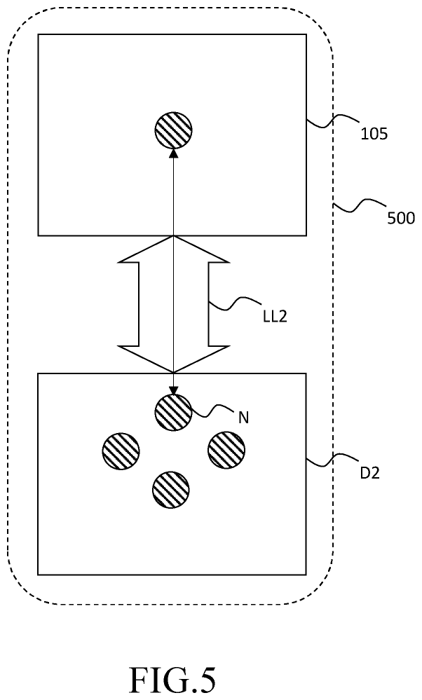

According to an exemplary and non-limitative embodiment of the present invention illustrated in FIG. 5, the exchange of commands and messages among the robot 105 and the selected device(s) Di listed in the supporting device list SUD through the local communication links LLi for performing the robot procedure RP is implemented exploiting the known Robot Operating System (ROS) framework, wherein the software applications SP corresponding to a generic procedure Pj are applications called ROS nodes N.

As it is known to those skilled in the art, the ROS nodes N are capable of interacting and exchanging data with each other through a message interface exploiting the publish-subscribe and request-response paradigms in the following three ways:
topic: a publisher application publishes a message on a topic, and the subscriber application subscribes to said topic for receiving the published messages (synchronous mechanism);
service: a server application processes a request message and returns a reply message to the client application (synchronous mechanism);
action: an action server application processes a goal message and returns feedback messages, during the processing, to the action client application, and when the processing is ended returns a result message to the action client application (hybrid asynchronous-synchronous mechanism).

Each selected device Di listed in the supporting device list SUD that is connected to the robot 105 through the respective communication link LLi is configured to share the ROS environment of the robot 105, schematically identified in FIG. 5 with reference 500. The ROS interface exposed by the ROS nodes N is shared between the robot 105 and the devices Di. The ROS nodes N are configured to control the operation of (the modules of) the robot 105 for performing the procedures Pj through proper ROS interfaces.

Returning to FIG. 2, according to an embodiment of the present invention, once all the procedures Pj of the robot procedure RP have been carried out, the remote server 150 causes the uninstallation of the software applications SP from the device(s) Di listed in the supporting device list SUD (block 212).

By making reference again to the sequence diagram illustrated in FIG. 4, according to an embodiment of the present invention the uninstallation is performed in the following way.

According to an embodiment of the present invention, when the last procedure Pj of the robot procedure RP has been carried out, meaning that the robot 105 completed the task TSK, the robot 105 sends (action 460) to the remote server 150 (exploiting the communication RL0 established between the robot 105 and the remote server 150) a request DEALLOC_(RP, SUD) to uninstall the software applications SP corresponding to the procedures Pj from the selected device(s) Di included in the supporting device list SUD (in the considered example, the device D2).

For example, by making reference to the example at issue in which the task TSK to be carried out relates to the opening of a closed door, the robot 105 may send the request DEALLOC_(RP, SUD) once the door is actually opened.

By making reference to the example at issue in which the software applications SP corresponding to the procedures Pj are ROS nodes N, a “closed door” event may be generated, through the publication of a corresponding ROS topic conveying a message reporting the door status. This message may be properly subscribed by a ROS node N that, once the message is processed, causes the request DEALLOC_(RP, SUD) be sent to the remote server 150.

According to an embodiment of the present invention, the remote server 150 then sends (action 470) to the device(s) Di listed in the supporting device list SUD a command STOP_UNLOAD(RP) for terminating the operation of the software applications SP installed in said device(s) Di, causing the uninstallation of the software applications SP from the device(s) Di, and possibly turning off (or putting in a passive state) the device(s) Di.

Naturally, in order to satisfy local and specific requirements, a person skilled in the art may apply to the invention described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

More specifically, the present invention lends itself to be implemented through an equivalent method (by using similar steps, removing some steps being not essential, or adding further optional steps); moreover, the steps may be performed in different order, concurrently or in an interleaved way (at least partly).

1. A method for controlling the operation of a robot in an environment, the robot being configured to exchange data with a remote server by establishing a robot-remote server communication through a communication network, the method comprising:
requiring the robot to perform a task in the environment;
generating a robot procedure adapted to be performed by the robot for executing the task, the robot procedure comprising a corresponding set of procedures each corresponding to one or more software applications comprising instructions for controlling the robot to perform the corresponding procedure;
selecting a set of at least one device, each device of the set having a processing unit configured to execute at least one of the software applications, each device of the set being located in the environment;
causing each device of the set of devices to download and install at least one of the software applications; and
controlling the robot to perform the robot procedure at least partially based on commands sent by at least one device of the set, the commands being generated by the at least one device by having the processing unit of the at least a device of the set executing the instructions of the installed at least one software application.

2. The method of claim 1, wherein the robot comprises at least one among the following robot modules:
actuator module configured to allow interaction of the robot with the environment;
locomotion module configured to allow movement of the robot in the environment; and
sensor module configured to collect data from the environment,
wherein the commands sent by a device of the set being for controlling the operation of at least one of said robot modules so as to perform at least one corresponding procedure.

3. The method of claim 1, wherein:
each device of the set located in the environment is configured to exchange data with the robot by establishing a corresponding local device-robot communication link without involving the communication network, the commands being sent to the robot by the least one device of the set through the corresponding local device-robot communication link,
a transmission latency of each local device-robot communication link is lower than a transmission latency of the robot-remote server communication between the robot and the remote server.

4. The method of claim 1, further comprising:
causing the robot to inspect the environment to identify devices in the environment; and
causing the robot to collect device hardware specifications of each one of the identified devices, wherein:
the selecting a set of at least one device comprises selecting the set of at least one device among the identified devices.

5. The method of claim 4, wherein the selecting a set of at least one device comprises having the remote server select the set of at least one device among the identified devices based on the collected device hardware specifications.

6. The method of claim 4, further comprising:
causing the robot to send to the remote server a robot procedure request for the generation of the robot procedure, the robot procedure request further comprising request parameters comprising at least one among:
the collected device hardware specifications,
a task description describing the task to be executed by the robot in the environment, and
hardware specifications of the robot,
causing the remote server to generate the robot procedure based on the request parameters.

7. The method of claim 6, further comprising:
causing the robot to collect data from the environment;
causing the robot to send the collected data to the remote server;
causing the remote server to generate the task description based on the received collected data; and
causing the remote server to send the generated task description to the robot.

8. The method of claim 6, further comprising:
causing a user of the remote server to generate said the task description; and
causing the remote server to send the generated task description to the robot.

9. The method of claim 1, further comprising c the remote server, once said robot procedure has been performed, cause each device of the set of devices to uninstall the at least one of said software applications that was installed in the device itself.

10. A system, comprising:
a robot located in an environment; and
a remote server, the robot being configured to exchange data with the remote server by establishing a robot-remote server communication through a communication network,
wherein:
the system is configured to generate a robot procedure adapted to be performed by the robot for executing a task in the environment, the robot procedure comprising a corresponding set of procedures each corresponding to one or more software applications comprising instructions for controlling the robot to perform the corresponding procedure,
the system is configured to select a set of at least one device, each device of the set having a processing unit configured to execute at least one of the software applications, each device of the set being located in the environment and being configured to exchange data with the robot, and
the system is configured to cause each device of the set of devices to download and install at least one of said software applications, and
wherein:
the robot is configured to perform the robot procedure at least partially based on commands sent by at least one device of the set, the commands being generated by the at least one device by having the processing unit of the at least a device of the set executing the instructions of the installed at least one software application.

11. A system according to claim 10, wherein:
the remote server is configured to generate the robot procedure configured to be performed by the robot for executing a task in the environment,
the remote server is configured to select the set of at least one device, and
the remote server is configured to cause each device of said set of devices to download and install at least one of said software applications.
